(19) United States
(12) Patent Application Publication
(10) Pub. No.: US 2010/0301819 A1
(43) Pub. Date: Dec. 2, 2010

(54) HIGH VOLTAGE GENERATING APPARATUS

(76) Inventor: In Soo WANG, Chungcheongbuk-do (KR)

Correspondence Address: IP & T GROUP LLP, 7700 Little River Turnpike, Suite 207, Annandale, VA, 22003, US

(21) Appl. No.: 12/648,397

(22) Filed: Dec. 29, 2009

(30) Foreign Application Priority Data
May 29, 2009 (KR) 10-2009-0047810

(51) Int. Cl. G05F 1/10

(52) U.S. Cl. 323/282

(57) ABSTRACT

A high voltage generating apparatus includes a regulator configured to control a pumping voltage at a voltage of a certain level, and an amplifier configured to amplify a current flowing through an output terminal of the regulator and to output an amplified current.

### CROSS-REFERENCE TO RELATED APPLICATION

Priority to Korean patent application number 10-2009-0047810 filed on May 29, 2009, the entire disclosure of which is incorporated by reference herein, is claimed.

### BACKGROUND

One or more embodiments relate to a high voltage generating apparatus and, more particularly, to a high voltage generating apparatus configured to supply high voltages to semiconductor memory devices.

When driving a semiconductor memory device, high voltages having several levels are necessary. A nonvolatile memory device that is recently being widely used requires a program voltage, a read voltage, and an erase voltage when respective program, read, and erase operations are performed.

The levels of such high voltages are higher than that of an external power source, and so the external power source is raised by a pump circuit, and then used as the high voltages.

The voltage outputted from the pump circuit is stabilized at a constant level through a regulator, before being used as one of the high voltages.

To generate the various levels of high voltages, an additional pump circuit and an additional regulator are used. That is, the additional pump circuit and the additional regulator are used for every high voltage.

With the recent development in the high integration of memory, high voltages are necessary, and therefore, it is necessary to improve the driving ability, so that the high voltages can be supplied. To improve the driving ability according to the generation of high voltages, a pump cell for generating a pumping voltage is designed to occupy a wide area. Accordingly, several concerns arise because the size of a peripheral area, including a pumping voltage supply circuit, is increased and space for a cell region is relatively decreased.

### BRIEF SUMMARY

One or more embodiments relate to a high voltage generating apparatus capable of improving driving ability.

A high voltage generating apparatus according to an aspect of this disclosure includes a regulator configured to control a pumping voltage at a voltage of a certain level, and an amplifier configured to amplify a current flowing through an output terminal of the regulator and to output an amplified current.

The amplifier comprises a bipolar transistor coupled between an input terminal and an output terminal of the regulator, and configured to have a base coupled with the output terminal of the regulator.

The regulator comprises a driver configured to transfer an input voltage to the output terminal, a voltage divider configured to divide a voltage supplied to the output terminal, and to generate a divided voltage, and a switching controller configured to compare a reference voltage and the divided voltage, and to control an operation of the driver according to a comparison result.

The driver comprises a first NMOS transistor. The first NMOS transistor has a gate coupled with the switching controller, a drain coupled with the input terminal, and a source coupled with the output terminal.

The switching controller comprises a comparator configured to compare the divided voltage and the reference voltage, and to output the comparison result, and a ground path unit configured to form a current path between the driver and a ground terminal according to the comparison result.

The comparator comprises an OP amp. The OP amp comprises an inverting terminal configured to receive the reference voltage and a non-inverting terminal configured to receive the divided voltage.

The ground path unit comprises a second NMOS transistor. The second NMOS transistor has a gate coupled with an output terminal of the comparator, a drain coupled with the driver, and a source coupled with a ground terminal.

The voltage divider comprises a first resistor and a second resistor coupled in series between a ground terminal and the output terminal of the regulator, and the divided voltage applied to the second resistor is inputted to the switching controller.

### BRIEF DESCRIPTION OF THE DRAWINGS

FIG. 1 is a diagram showing a conventional pumping unit of a high voltage generating apparatus;

FIG. 2 is a diagram showing a pumping unit of a high voltage generating apparatus according to an embodiment of this disclosure;

FIG. 3 is a circuit diagram showing a regulator of a high voltage generating apparatus according to an embodiment of this disclosure; and

FIG. 4 is a block diagram showing a high voltage generating apparatus according to an embodiment of this disclosure.

### DESCRIPTION OF EMBODIMENT

Hereinafter, some embodiments of the present disclosure will be described in detail with reference to the accompanying drawings. The figures are provided to allow those having ordinary skill in the art to understand the scope of the embodiments of the disclosure.

FIG. 4 is a block diagram showing a high voltage generating apparatus according to an embodiment of this disclosure.

Referring to FIG. 4, the high voltage generating apparatus of this disclosure includes a pumping unit 200 configured to raise an input voltage VDD using a number of pump cells, a regulator 300 configured to control the pumping voltage VPP, outputted from the pumping unit 200, at a voltage of a certain level, and an amplifier 320 configured to amplify current flowing through the output terminal of the regulator 300, and to output an output voltage VREG.

The high voltage generating apparatus of the present disclosure is described below with reference to FIGS. 1 to 3.

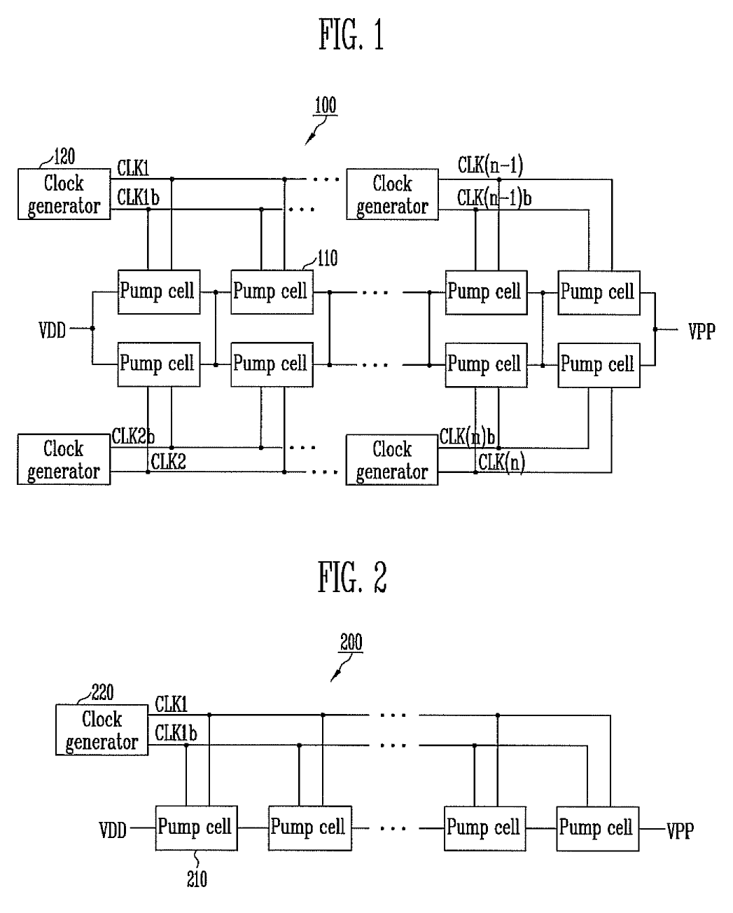

FIGS. 1 and 2 are diagrams showing pumping units 100 and 200 of the high voltage generating apparatus.

Referring to FIG. 1, the pumping unit 100 has a structure, including a number of pump cells 110. The pump cells 110 are connected so that each pump cell 110 is coupled in parallel with one other pump cell 110 to form a pair of pump cells 110, and each pair of pump cells 110 is connected in series with the other pairs of pump cells 110. Clock signals generated by a clock generator 120 are inputted to each of the pump cells 110. Further, each pump cell 110 is configured to raise voltage using the clock signals received from the clock generator 120.

In the pumping unit 100, the input voltage VDD is pumped by a number of the pump cells 110 and outputted as the pumping voltage VPP. Here, the pumping unit 100 is designed to have a structure in which a number of the pump cells 110 are coupled together to improve the driving ability. Such a design is disadvantageous in that the pumping unit 100 occupies a large area. The present disclosure proposes a structure capable of reducing the area occupied by the pumping unit 100 by improving the driving ability of the regulator 300.

FIG. 2 is a diagram showing the pumping unit 200 of the high voltage generating apparatus according to an embodiment of this disclosure.

Referring to FIG. 2, the pumping unit 200 is configured to have a number of pump cells 210 coupled together in series, and to raise the input voltage VDD using the pump cells 210 and output the pumping voltage VPP. Here, clock signals generated by a clock generator 220 are inputted to each of the pump cells 210. The clock signals include a first clock signal CLK1 and a second clock signal CLK1b having opposite phases. In the present disclosure, each of the pump cells 210 pumps the input voltage using the first clock signal CLK1 and the second clock signal CLK1b having opposite phases.

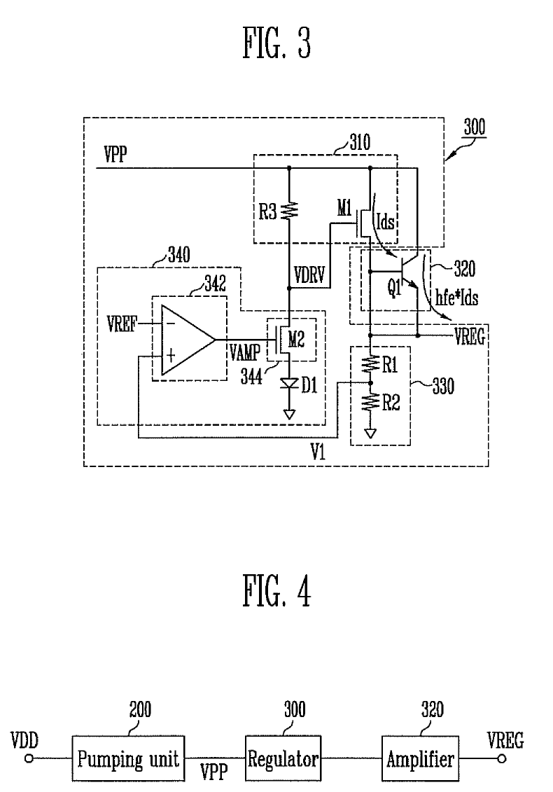

FIG. 3 is a circuit diagram showing the regulator 300 of the high voltage generating apparatus according to an embodiment of this disclosure. The regulator 300 is configured to control the pumping voltage VPP, outputted from the pumping unit 200, at a voltage of a certain level.

Referring to FIG. 3, the regulator 300 includes a driver 310, a voltage divider 330, and a switching controller 340.

The driver 310 is configured to transfer an input voltage VPP to the output terminal of the regulator 300. The driver 310 includes a first NMOS transistor M1 having a gate coupled with the switching controller 340, a drain coupled with the input terminal of the regulator 300, and a source coupled with the output terminal of the regulator 300. The driver 310 further includes a third resistor R3 coupled between the input terminal and the switching controller 340.

The regulator 300 may further include an amplifier 320.

The amplifier 320 is coupled between the input and output terminals of the regulator 300 and is configured to amplify current flowing through the output terminal. The amplifier 320 includes a bipolar transistor Q1 having a base coupled with the output terminal of the regulator 300. In the present disclosure, current flowing through the output terminal of the regulator 300 is increased by a characteristic of the bipolar transistor Q1. That is, assuming that current outputted from the first NMOS transistor M1 is ‘Ids’, the current ‘Ids’ is amplified by a current gain ‘life’ of the bipolar transistor Q1 through the amplifier 320, and then outputted to the output terminal of the regulator 300. That is, current at the output terminal of the regulator 300 becomes hfe*Ids. For reference, the current gain ‘hfe’ of the bipolar transistor Q1 is calculated by dividing a current, flowing through the collector of the bipolar transistor Q1, by a current flowing through the base of the bipolar transistor Q1.

Although the amplifier 320 is illustrated and described as a separate element not included in the regulator 300, the amplifier 320 may be included in the regulator 300 according to some embodiments.

The voltage divider 330 is configured to divide an output voltage VREG of the regulator 300. The voltage divider 330 includes a first resistor R1 and a second resistor R2 coupled in series between a ground terminal and the output terminal of the regulator 300. Voltage applied to the second resistor R2 becomes a divided voltage V1, which is applied to a comparator 342. The voltage divider 330 is configured to output the divided voltage V1 according to a ratio of resistances of the first resistor R1 and the second resistor R2.

The switching controller 340 includes the comparator 342 and a ground path unit 344. The switching controller 340 is configured to compare the divided voltage V1 and a reference voltage VREF and to control the operation of the driver 310 according to the comparison result.

The comparator 342 is configured to compare the divided voltage V1 and the reference voltage VREF and to output an amp output voltage VAMP. The comparator 342 includes an OP amp. The reference voltage VREF is inputted to the inverting terminal (− terminal) of the OP amp, and the divided voltage V1 is applied to the non-inverting terminal (+ terminal) of the OP amp.

The ground path unit 344 is coupled with the driver 310. The ground path unit 344 operates according to the comparison result outputted from the comparator 342 and forms a current path between the driver 310 and a ground terminal. The ground path unit 344 includes a second NMOS transistor M2 having a gate coupled with the output terminal of the OP amp, a drain coupled with the driver 310, and a source coupled with the ground terminal. For example, when a high-level signal is outputted from the comparator 342, the second NMOS transistor M2 is turned on, and so the driver 310 is coupled with the ground terminal. However, when a low-level signal is outputted from the comparator 340, the second NMOS transistor M2 is turned off. The diode D1 of the switching controller 340 functions to prevent a counter-flow of current.

The operation of the regulator 300 is described below with reference to FIG. 3. When the pumping voltage VPP is inputted to the driver 310 of the regulator 300, the first NMOS transistor M1 operates in a linear region, and so an output voltage VREG rises. At this time, the divided voltage V1 outputted from the voltage divider 330 also rises.

The OP amp of the comparator 342 compares the divided voltage V1 and the reference voltage VREF. If, as a result of the comparison, the divided voltage V1 is higher than the reference voltage VREF, the OP amp outputs the amp output voltage VAMP of a high voltage level. If the reference voltage VREF is higher than the divided voltage V1, the OP amp outputs the amp output voltage VAMP of a low voltage level.

When the amp output voltage VAMP of a low voltage level is inputted to the second NMOS transistor M2 of the ground path unit 344, the second NMOS transistor M2 is turned off, and so the gate voltage VDRV of the first NMOS transistor M1 rises. When the gate voltage VDRV of the first NMOS transistor M1 rises, the voltage between the gate and the source of the first NMOS transistor M1 rises, and a greater amount of current flows into the output terminal of the regulator 300, thereby raising the output voltage VREG. At this time, the current ‘Ids’ outputted from the source of the first NMOS transistor M1 is inputted to the base of the bipolar transistor Q1 of the amplifier 320. The bipolar transistor Q1 amplifies the current ‘Ids’ as much as a current gain ‘hfe,’ and outputs an amplified current to the output terminal of the regulator 300.

As described above, since the bipolar transistor Q1 amplifies the current ‘Ids,’ and outputs an amplified current to the output terminal of the regulator 300, the current of the output terminal of the regulator 300 rises in a period in which the pumping voltage VPP rises. Accordingly, the output voltage VREG can rapidly become close to a target voltage. Further, in a period in which the pumping voltage VPP falls, the output voltage VREG is prevented from dropping. Accordingly, the output voltage VREG can be rapidly regulated to a stabilized voltage level.

When the amount of the output voltage VREG rises as described above, the divided voltage V1 increases in proportion to the output voltage VREG. Thus, when the divided voltage V1 becomes higher than the reference voltage VREF, the OP amp of the comparator 342 outputs the amp output voltage VAMP of a high voltage level. When the amp output voltage VAMP of a high voltage level is inputted to the second NMOS transistor M2 of the ground path unit 344, the second NMOS transistor M2 is turned on, and so the gate voltage VDRV of the first NMOS transistor M1, coupled with the drain of the second NMOS transistor M2, decreases. When the gate voltage VDRV of the first NMOS transistor M1 decreases, the voltage between the gate and the source of the first NMOS transistor M1 decreases. Consequently, current flowing into the output terminal of the regulator 300 decreases, and so the output voltage VREG decreases. Accordingly, the regulator 300 can maintain a constant voltage level by performing a regulation operation as described above.

As described above with reference to FIG. 3, the output current ‘Ids’ is amplified by the current gain ‘hfe’ of the bipolar transistor Q1, and then outputted. Accordingly, a current characteristic can be improved, and the driving ability can be improved.

Further, as shown in FIG. 2, the pump cells 210 of the pumping unit 200 can be coupled together in series. Accordingly, the area occupied by a high voltage generating apparatus can be reduced.

The present disclosure is advantageous in that it can improve the driving ability of the regulator using the bipolar transistor. The present disclosure is also advantageous in that it can reduce the area occupied by a high voltage generating apparatus by reducing the number of pump cells included in a pumping unit because of the improved driving ability.

What is claimed is:

1. A high voltage generating apparatus, comprising:
a regulator configured to control a pumping voltage at a voltage of a certain level; and
an amplifier configured to amplify a current flowing through an output terminal of the regulator and to output an amplified current.

2. The high voltage generating apparatus of claim 1, wherein the amplifier comprises a bipolar transistor coupled between an input terminal and an output terminal of the regulator, and configured to have a base coupled with the output terminal of the regulator.

3. The high voltage generating apparatus of claim 1, wherein the regulator comprises:
a driver configured to transfer an input voltage to the output terminal;
a voltage divider configured to divide a voltage supplied to the output terminal, and to generate a divided voltage; and
a switching controller configured to compare a reference voltage and the divided voltage, and to control an operation of the driver according to a comparison result.

4. The high voltage generating apparatus of claim 3, wherein the driver comprises a first NMOS transistor.

5. The high voltage generating apparatus of claim 4, wherein the first NMOS transistor has a gate coupled with the switching controller, a drain coupled with the input terminal, and a source coupled with the output terminal.

6. The high voltage generating apparatus of claim 3, wherein the switching controller comprises:
a comparator configured to compare the divided voltage and the reference voltage, and to output the comparison result, and
a ground path unit configured to form a current path between the driver and a ground terminal according to the comparison result.

7. The high voltage generating apparatus of claim 6, wherein the comparator comprises an OP amp.

8. The high voltage generating apparatus of claim 7, wherein the OP amp comprises an inverting terminal configured to receive the reference voltage and a non-inverting terminal configured to receive the divided voltage.

9. The high voltage generating apparatus of claim 6, wherein the ground path unit comprises a second NMOS transistor.

10. The high voltage generating apparatus of claim 9, wherein the second NMOS transistor has a gate coupled with an output terminal of the comparator, a drain coupled with the driver, and a source coupled with a ground terminal.

11. The high voltage generating apparatus of claim 3, wherein:
the voltage divider comprises a first resistor and a second resistor coupled in series between a ground terminal and the output terminal of the regulator, and
the divided voltage applied to the second resistor is inputted to the switching controller.
